(19) United States
(12) Patent Application Publication
(10) Pub. No.: US 2021/0188490 A1
(43) Pub. Date: Jun. 24, 2021

(54) Reusable Drink Protector

(71) Applicants: Andrew Cohan, Los Angeles, CA (US); Jessica Thomas, Los Angeles, CA (US)

(72) Inventors: Andrew Cohan, Los Angeles, CA (US); Jessica Thomas, Los Angeles, CA (US)

(21) Appl. No.: 16/721,917

(22) Filed: Dec. 20, 2019

(51) Int. Cl. B65D 43/02; A47G 19/22

(52) U.S. Cl. CPC B65D 43/0202; B65D 2543/00537; A47G 2400/123; A47G 19/2211

(57) ABSTRACT

A reusable drink protector made of flexible silicone sheet material. The sheet is approximately circular in shape and has a plurality of outwardly extending tabs. Each tab includes a semi adhesive disk. The circular portion of the sheet can close off the top surface of a glass or cup. The tabs can bend down the sides of the cup and be adhered to the cup by the semi adhesive disks. One extension tab has a magnet attached. When the user wants to drink from the cup, he or she folds up the extension tab and attaches the magnet to a metal disk mounted on the circular sheet creating an uncovered space on the edge of the cup for the user to drink from. The drink protector can be rolled up and stored in a tubular container.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of protective covers for beverage cups or glasses and more specifically to reusable drink protector.

Beverages of all types are commonly served in cups or glasses when frequenting a restaurant, bar, concert, festival, or simply visiting person's home. On some occasions, a person other than the one holding the drink my attempt to deposit a mind or body altering chemical to make the drink holder drowsy or otherwise incapacitated.

To this end, some manufacturers have started selling protective lids that are meant to cover the top surface of a glass or cup when the user is not actually in the process of drinking the beverage, such as the “Charles Viancin Autumn Drink Covers” available on Amazon.

However, there is a deficiency in the prior technology in that the user must fully remove and replace the protective cover each time he or she wants to drink from the glass or cup, forcing the user to either put the lid down on a table or to hold the lid in his or her hand until ready to re-cover the glass or cup. Additionally, many current covers do not fit snuggly onto the top of the glass or cup making it possible for a second person to quickly remove the lid, place a mind or body altering pill, liquid or powder into the cup or glass and then quickly replace the lid. Finally, the current lids are somewhat cumbersome to carry in that they cannot be rolled up or otherwise made more compact for storage and transport purposes.

### BRIEF SUMMARY OF THE INVENTION

The primary object of the invention is to provide a reusable drink protector that can temporarily cover the top surface of an open topped vessel such as a cup or glass thereby reducing the possibility of a person, other than the drink holder, depositing unwanted substances into the drink.

Another object of the invention is to provide a reusable drink protector that can temporarily adhere to the side surface of a glass.

Another object of the invention is to provide a reusable drink protector that allows the user to lift and secure a portion of the protecting panel in such a way as to allow the user to drink from the glass without completely removing the drink protector.

A further object of the invention is to provide a reusable drink protector that can roll up and be stored in a tubular housing.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a reusable drink protector comprising: a silicone sheet, a magnet, a ferrous disk member, a plurality of semi adhesive disk members, said silicone sheet being flexible and food grade, said silicone sheet being approximately circular and having a plurality of outwardly extending tabs, said plurality of semi adhesive disk members each attached to each end of said outwardly extending tabs, said circular portion of said silicone sheet capable of laying on top of an open topped vessel, said open topped vessel being a cup or glass capable of retaining a beverage, said plurality of said outwardly extending tabs capable of folding down over the sides of said cup or glass and being releasably retained to said cup or glass by said semi adhesive disks, said silicone sheet having said magnet attached to the flat surface at the end of one of said outwardly extending tabs, said silicon sheet having a ferrous metal disk attached to said circular portion of said silicon sheet, said magnet holding tab capable of being folded up and over the top of said circular silicone sheet so that said magnet engages said ferrous metal disk enabling a user to drink from the exposed lip of said cup or glass, and said magnet holding tab capable of being detached from said ferrous disk member and returned to the side of said cup or said glass via said semi adhesive disk member.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention with the reusable drink protector fully in place on a cup.

FIG. 2 is a top perspective view of the invention in the flattened position.

FIG. 3 is a bottom perspective view of the invention in the flattened position.

FIG. 4 is a perspective view of the invention about to be placed on a cup.

FIG. 5 is a perspective view of the invention with one tab partially lifted.

FIG. 6 is a perspective view of the invention with the tab fully lifted and in place on top of the circular portion of the drink protector.

FIG. 7 is an exploded view of the invention rolled up and about to be inserted into a tubular carrying case.

FIG. 8 is a perspective view of the carrying case in the closed position.

### DETAILED DESCRIPTION OF THE DRAWINGS AND PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

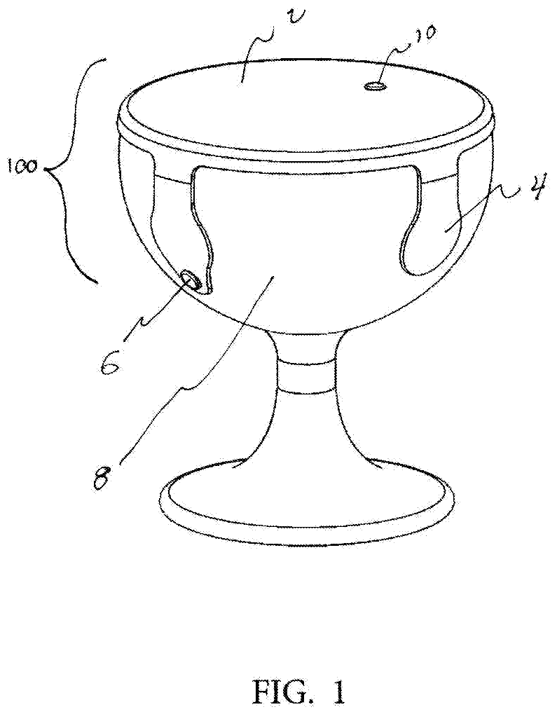

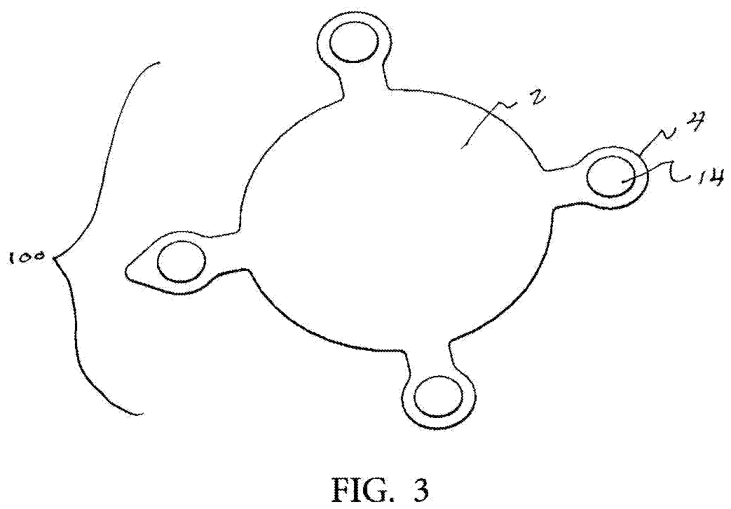

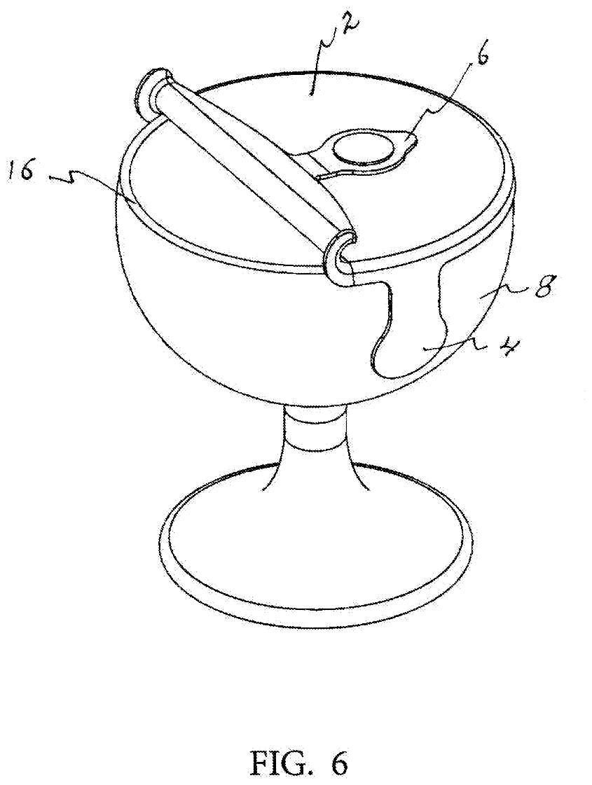

Referring now to FIG. 1 we see a perspective view of the invention 100 covering a cup 8. A circular portion 2 covers the entire top of the cup 8 and a plurality of extension members 4 attach to the side walls of the cup 8 via semi adhesive disks shown in FIG. 3. In the present embodiment, four equally spaced extension members are used, however the invention will work with fewer or more extension members 4. Magnetic member 6 is fixedly attached to one of the extension members 4. The magnet 6 can engage a ferrous metal disk 10 that is attached to the circular portion 2 as shown in FIG. 6.

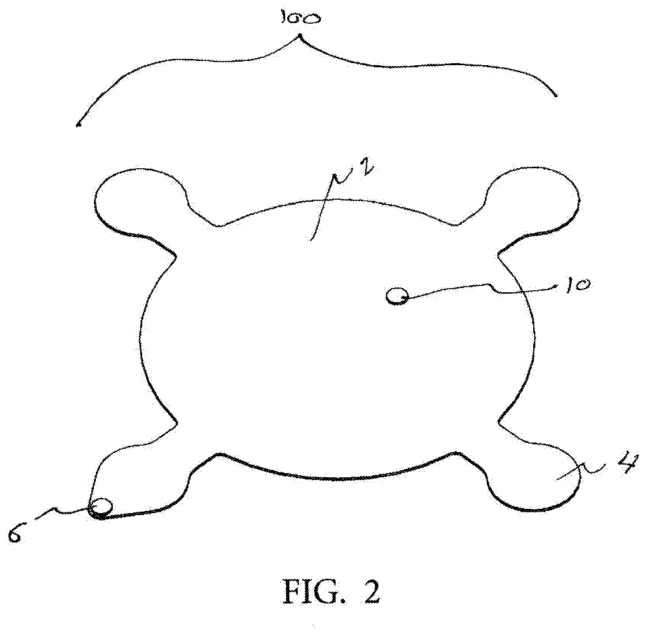

FIG. 2 is a perspective view of the top surface of the invention 100 in the flat position. The invention 100 is made of flexible food grade silicone having a durometer of approximately forty and a thickness of approximately sixty thousandths of an inch. The extension members 4 are spaced equally. Each extension member 4 is identical except for one that includes magnet 6 which is slightly longer than the rest.

FIG. 3 is a perspective view of the under surface of the invention 100 showing semi adhesive disks 14. All extensions 4 have disks 14 fixedly attached to them. The semi adhesive disks are similar to “Gekkodots Reusable Adhesive Dots” available on-line or in retail stores, except that one side of the disk 14 has permanent adhesive that attaches them to the silicone disk 2 and one side is semi adhesive which removably attaches to the side of a cup or glass.

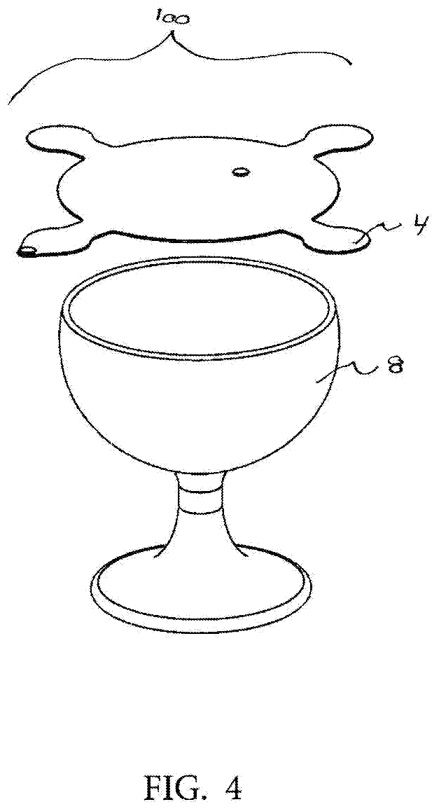

FIG. 4 is a perspective view of the invention 100 about to be installed on a cup 8.

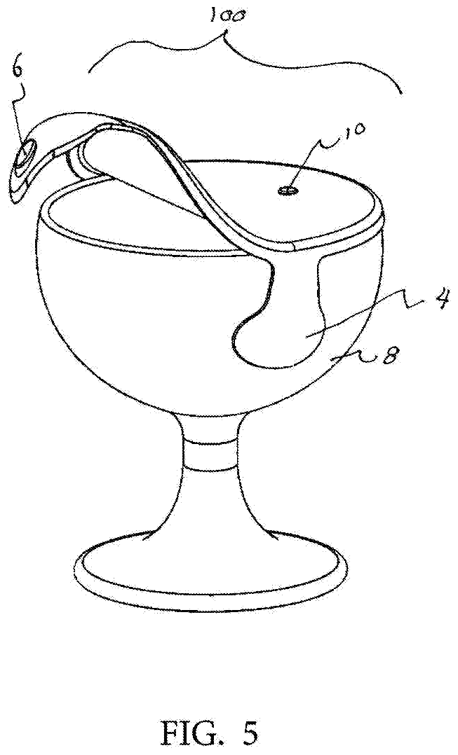

FIG. 5 is a perspective view of the invention 100 attached to the cup 8 on three sides with the fourth extension member partially lifted and about to be folded completely so that magnet 6 engages ferrous disk 10 and holds it in place as shown in FIG. 6, leaving a free space 16 for the user to partake of the beverage held within cup 8 without needing to completely remove the protective lid 100. In this way, a user can keep his or her beverage completely protected from possible insertion of an unwanted material from a person other than the holder of the cup 8 while not drinking the beverage, and conveniently remove and fold one extension arm over the circular portion 2 to have access to an edge of the cup for drinking.

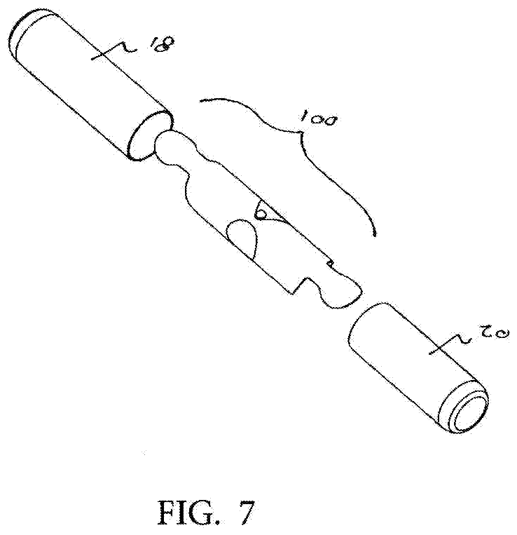

FIG. 7 is a perspective view of the invention 100 in the rolled-up condition, and ready to be inserted into tubular container 18, 20. The container keeps the protective cover 100 free from dirt or germs during storage and provides a convenient way to carry the protective cover 100 in one's purse or pocket.

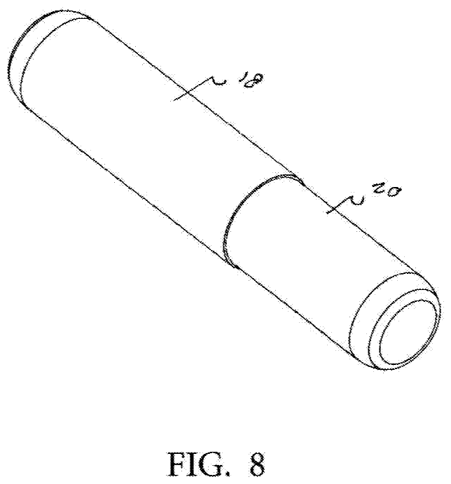

FIG. 8 is a perspective view of the tubular container in the closed position with the protective cover safely inside.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A reusable drink protector comprising:
a silicone sheet;
a magnet;
a ferrous disk member;
a plurality of semi adhesive disk members;
said silicone sheet being flexible and food grade;
said silicone sheet being approximately circular and having a plurality of outwardly extending tabs;
said plurality of semi adhesive disk members each attached to each end of said outwardly extending tabs;
said circular portion of said silicone sheet capable of laying on top of an open topped vessel;
said open topped vessel being a cup or glass capable of retaining a beverage;
said plurality of outwardly extending tabs capable of folding down over the sides of said cup or glass and being releasably retained to said cup or glass by said semi adhesive disks;
said silicone sheet having said magnet attached to the flat surface at the end of one of said outwardly extending tabs;
said silicon sheet having a ferrous metal disk attached to said circular portion of said silicon sheet;
said magnet holding tab capable of being folded up and over the top of said circular silicone sheet so that said magnet engages said ferrous metal disk enabling a user to drink from the exposed lip said cup or glass; and
said magnet holding tab capable of being detached from said ferrous disk member and returned to the side of said cup or said glass via said semi adhesive disk member.

2. A reusable drink protector as claimed in claim 1 further comprising a tubular container capable of receiving and storing said reusable drink protector in a rolled-up configuration.

3. A reusable drink protector as claimed in claim 1 wherein said silicone sheet is approximately sixty thousandths of an inch thick and forty shore in durometer.

4. A reusable drink protector as claimed in claim 1 wherein said plurality of outwardly extending tabs total four and are equally spaced around the perimeter of said circular portion.
